(19) United States
(12) Patent Application Publication
(10) Pub. No.: US 2023/0204485 A1
(43) Pub. Date: Jun. 29, 2023

(54) OPTICAL PARTICLE DETECTION SYSTEM AND OPTICAL PARTICLE DETECTING METHOD

(71) Applicant: TRIPLE WIN TECHNOLOGY(SHENZHEN) CO.LTD., Shenzhen (CN)

(72) Inventors: WEN-CHING LAI, New Taipei (TW); YU-AN CHO, New Taipei (TW); YA-JIE NIU, JinCheng (CN)

(21) Appl. No.: 17/683,494

(22) Filed: Mar. 1, 2022

(30) Foreign Application Priority Data
Dec. 24, 2021 (CN) 202111601626.4

(51) Int. Cl. G01N 15/02

(52) U.S. Cl. CPC G01N 15/0227; G01N 15/0211

(57) ABSTRACT

An optical particle detection system includes a light source, a lens group, an absorber, a microscope group, a filter, an image sensor, and a host. Laser is emitted from the light source, the lens group is configured to reflect and expand the laser light. The absorber absorbs a plurality of particles and presents the particles to an optical path of the laser light expanded by the lens group. The microscope group amplifies an image of the particles. The filter filters the laser light from the microscope group. The image sensor converts the laser light filtered by the filter into an electrical signal and the host analyzes the electrical signal and determines quality and components of at least one target particle in the particles.

### FIELD

The present disclosure generally relates to an optical particle detection system and an optical particle detecting method applied in the optical particle detecting system.

### BACKGROUND

Particulate matter in the atmosphere is a general name of various solid and liquid particles in the atmosphere. The particles are evenly and stably dispersed in the air to form a huge suspension system, namely aerosol system. Fine particles have a slow settling speed and remain in the atmosphere for a long time, and such fine particles can be blown to far places under atmospheric turbulence, which can pollute a vast area. The fine particles floating evenly in the air have a strong scattering and absorption of visible light, which significantly weakens light signals and reduces an atmospheric visibility. PM2.5 refers to particles having a diameter less than or equal to 2.5 microns in the atmosphere, a size small enough to be accessible to the lungs. Although the PM2.5 has a small size, it is rich in toxic and harmful substances, and it can be inhaled and deposited into human bronchi and alveoli, which is very harmful to human health.

A conventional method for detecting particles determines the nature of particles by analyzing a spectral image of the particles, but a detection speed is limited. An optical detection system of the prior art is complex, and imaging of the particles for analysis is affected by many factors, which increases a detection difficulty.

### BRIEF DESCRIPTION OF DRAWINGS

FIG. 1 shows an optical particle detection system in an embodiment of the present disclosure.

FIG. 2 is a flow chart of an optical particle detecting method in an embodiment of the present disclosure.

FIG. 3 is a black-and-white picture generated by block S2 in the flow chart of FIG. 2.

### DETAILED DESCRIPTION

The present disclosure provides an optical particle detecting system. The system can be installed in a specific environment according to user's needs to continuously monitor the air in the environment. The system can also be a mobile device, which can be taken to different environments according to user's needs to measure an air quality of different environments in real time.

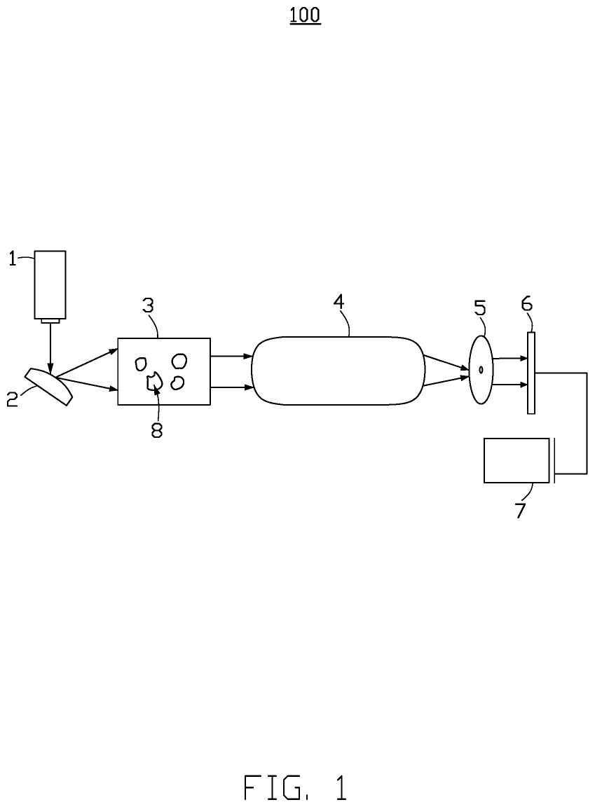

As shown in FIG. 1, in an embodiment of the present disclosure, the detecting system 100 includes a light source 1, a lens group 2, an absorber 3, a microscope group 4, a filter 5, an image sensor 6, and a host 7.

The light source 1 is used to emit laser light. The lens group 2 is used to reflect and expand the laser light. The lens group 2 includes, for example, one or more expanding lenses for expanding the laser light received, one or more collimating lenses for collimating the laser light received, and one or more mirrors for reflecting the laser light received. The lens group 2 is between the light source 1 and the absorber 3. The laser light from the light source 1 is incident on the absorber 3 after expansion, collimation, and/or reflection by the lens group 2. The absorber 3 is used to absorb particles 8 and present the particles 8 on an optical path of the laser light reflected and expanded by the lens group 2. The microscope group 4 is used to amplify an image of the particles 8. The filter 5 is used to filter the laser light passing through the microscope group 4 to obtain laser light having a target wavelength. The image sensor 6 is used to convert the laser light filtered by the filter 5 into electrical signal. The host 7 calculates and analyze the electrical signal from the image sensor 6 and determine a quantity and elemental components of at least one target particle in the particles 8.

Specifically, the laser light scattered and reflected by the particles 8 forms the image of the particles 8, and the microscope group 4 is configured to amplify the image of the particles 8. When the laser light from the microscope group 4 reaches the filter 5, stray light around the image of the particles 8 is filtered and removed by the filter 5. A part of the laser light amplified by the microscope group 4 and a part of the laser light forming an image of the target particle(s) can pass through the filter 5 (that is, the filter 5 is configured to transmit the part of the laser light amplified by the microscope group 4 and form the image of the target particle).

The image sensor 6 is configured to convert the laser light filtered by the filter 5 into the electrical signal with a certain signal strength to form an image based on the signals (electrical image). The host 7 is electrically connected to the image sensor 6 and is configured to calculate and analyze the electrical image from the image sensor 6 to select the target particle(s) from the particles 8. The host 7 is further configured to calculate the quantity of the target particle(s) and determine the elemental components of the target particle(s) according to a preset database. In the present embodiment, the host 7 may be a computer, a smart terminal, a circuit, or a chip. In the present embodiment, the preset database includes a plurality of particles and a plurality of color modules and elemental components corresponding to the particles.

In an embodiment of the present disclosure, the light source 1 is an ultraviolet laser, which emits the laser light having a wavelength less than 400 nm. The laser light with a wavelength less than 400 nm has a good directivity, high intensity, and large output energy.

In an embodiment of the present disclosure, the optical path of the laser light between the light source 1 and the lens group 2 forms a non-zero angle with the optical path of the laser light between the lens group 2 and the image sensor 6, which improves an imaging quality of the image sensor 6. Further, the laser light from the light source 1 to the lens group 2 and the laser light from the lens group 2 to the absorber 3 are not conjoined or parallel. In other words, the laser light from the light source 1 to the lens group 2 forms a non-zero angle with the laser light from the lens group 2 to the absorber 3.

In an embodiment of the present disclosure, the absorber 3 can collect particles in the atmosphere, especially particles with diameters less than or equal to 2.5 μm. In this embodiment, the particles 8 are collected from the atmosphere and have diameters less than or equal to 2.5 μm.

In an embodiment of the present disclosure, the microscope group 4 is designed for atmospheric particles, especially for particles with diameters less than or equal to 2.5 μm. The microscope group 4 can effectively amplify the image of the particles with diameters less than or equal to 2.5 μm. The part of the laser light forming the amplified image of the particles with diameters less than or equal to 2.5 μm can pass through the filter 5. The microscope group 4 includes at least one or more microscopic objective lenses for amplifying the image of the particles.

In an embodiment of the disclosure, the filter 5 is a single pinhole filter, which is especially suitable for atmospheric particles. By filtering out stray light around the image of the particles, the image sensor 6 to able to more accurately distinguish a size of the image. Stray light includes diffracted light from the light source 1, scattered light from the absorber 3, and reflected light from the microscope group 4, etc.

In an embodiment of the present disclosure, a sensing range of the image sensor 6 matches the wavelength range of the laser light from the light source 1. When the light source 1 is an ultraviolet laser, the image sensor 6 can sense light with a wavelength less than 400 nm (the sensing range includes light with wavelength less than 400 nm).

In an embodiment of the present disclosure, the image sensor 6 is a complementary metal oxide semiconductor (CMOS) image sensor, which include a chip integrated with a pixel array and peripheral support circuits (such as image sensor core, single clock, all time sequence logic, programmable functions, and analog-to-digital converter). The image sensor 6 has the character of small volume, light weight, low power consumption, convenient programming, and ease of control. The CMOS image sensor includes a plurality of pixels arranged in an array. Each pixel is square, and a pixel size of the CMOS image sensor is defined as a side length of the square. In one embodiment, the pixel size of the CMOS image sensor is 0.7 μm, but is not limited to this.

Compared with the prior art, the particles 8, which are samples processed by the particle optical detecting system 100 provided in this embodiment of the disclosure, is obtained by the absorber 3 in the particle optical detecting system 100, which makes a sampling space and a sampling time more flexible. In this embodiment of the disclosure, the microscope group 4 and filter 5 are used to preprocess the image of particles 8, which improves the imaging quality. In this embodiment of the disclosure, the image sensor 6 is used to convert the image of the particulate matter 8 into the electrical signal with certain strengths, which reduces difficulty of obtaining images of atmospheric particles.

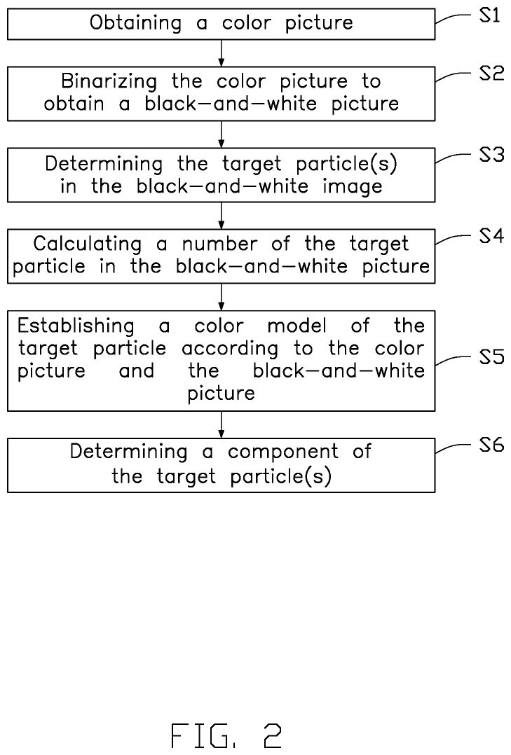

An embodiment of the disclosure provides an optical particle detecting method, which can be applied to the particle optical detecting system shown in FIG. 1 to detect the particles 8. As shown in FIG. 2, the optical particle detecting method includes the following blocks.

Block S1, obtaining a color picture.

Specifically, a color picture is obtained by the image sensor 6, which includes a color image of the particles 8.

Block S2, binarizing the color picture to obtain a black-and-white picture.

Specifically, the host 7 is configured to determine grayscale levels of pixels in the color picture. Each pixel with a grayscale level greater than or equal to a threshold is determined to be corresponding to the target particle and its grayscale level is represented by 255. Each pixel with a grayscale level less than the threshold is determined to be not corresponding to the target particle and its grayscale level is represented by 0. That is, pixels having grayscale levels less than the threshold correspond to a background or particles other than the target particle(s). Therefore, the black-and-white picture including black-and-white images of the particles are obtained.

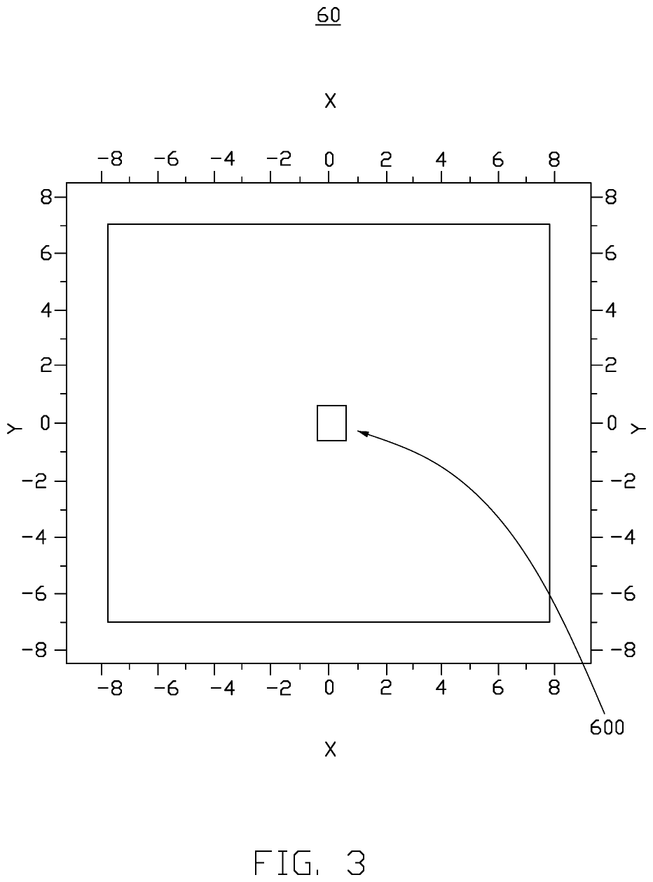

FIG. 3 shows a black-and-white picture 600 of only one particle in the particles 8 obtained by the block S2 in FIG. 2, as an example. A rectangular coordinate system including an X axis and a Y axis is established in FIG. 3. Sizes of the axes and the black-and-white image 600 of the particle in FIG. 3 do not represent real sizes of the image obtained by the imaging sensor. The black-and-white image 600 of the particle portrays a clear and accurate position in the rectangular coordinate system.

Block S3, determining the target particle(s) in the black-and-white image.

Specifically, the host 7 is configured to determine a pixel number of the black-and-white image 600 of the particle in the black-and-white picture 60. If a diameter of the target particle is less than or equal to A1 and the pixel size of the image sensor 6 is A2, it is determined whether the black-and-white image 600 of the particle is less than or equal to A1/A2. It is determined that the particle is the target particle if the black-and-white image 600 of the particle is less than or equal to A1/A2 and the position of each target particle in the black-and-white picture is marked.

In an embodiment of the present disclosure, if the diameter of the target particle is less than or equal to 2.5 μm (that is, A1=2.5 μm), the pixel size of the image sensor 6 is 0.7 μm (that is, A2=0.7 μm). In the black-and-white picture, the particle which has a black-and-white image less than or equal to 3.57 is defined as the target particle in the black-and-white picture. In other embodiments, values of A1 and A2 are not limited.

Block S4, calculating a number of the target particles in the black-and-white picture.

Specifically, the host 7 is configured to calculate a number of positions marked in the black-and-white picture and so determine the number of the target particles.

Block S5, establishing a color model of the target particles according to the color picture and the black-and-white picture.

Specifically, the host 7 is configured to obtain a color image and picture of the target particle(s) according to the positions of the target particle(s) in the black-and-white picture, and establish a color model of the target particle(s) based on the color image of the target particle(s) in the color picture.

In one embodiment, a hue-saturation-intensity (HSI) color model of the target particle(s) is established by analyzing hue, saturation, and intensity of the color image of the target particle(s) in the color picture. In other embodiments, other color models can be established by analyzing other features of the color image of the target particle(s) in the color picture, such as hue-saturation-value (HSV) color model.

Block S6, determining a nature of the target particle(s).

Specifically, the host 7 includes a memory (not shown) and a processor (not shown) electrically connected to the memory. The memory is used to store one or more computer programs configured to be executed by the processor. The one or more computer programs include a plurality of instructions. The optical particle detecting method is achieved when the plurality of instructions are executed by the processor. A database of color models of various particles with different components is pre-stored in the memory. The nature of the target particle(s) can be determined by comparing the color module of target particle(s) to color modules in the database. Color modules of two particles have a common nature. The memory may include a random-access memory, a hard disk, an optical disc, a USB flash disk, etc. The processor may include a graphics processor, an image signal processor, a digital signal processor, and the like.

Compared with the prior art, the optical detecting method provided in this embodiment of the disclosure uses a relationship between the size of the target particle(s) and the pixel size of the image sensor to automatically identify the target particle(s) from the image and automatically determine the quantity of the target particle(s), which improves a recognition speed of the target particle(s). In this embodiment of the disclosure, the color module of the target particle(s) is established, and the database of color module is used to compare with the color model of the target particle(s), which identifies the nature of the target particle(s).

Ordinary technicians in the technical field should realize that the above embodiments are only used to illustrate the present disclosure and not to limit the present disclosure. Appropriate changes made to the above embodiments fall within a protection scope of the present disclosure as long as the changes are within a substantive spirit of the present disclosure.

What is claimed is:

1. An optical particle detection system comprising:
a light source configured to emit laser light;
a lens group configured to reflect and expand the laser light;
an absorber configured to absorb a plurality of particles comprising at least one target particle and provide the plurality of particles to an optical path of the laser light expanded by the lens group;
a microscope group configured to amplify an image of the plurality of particles;
a filter configured to filter the laser light from the microscope group;
an image sensor configured to convert the laser light filtered by the filter into electrical signal; and
a host configured to analyze the electrical signal and determine a number and a component of the at least one target particle in the plurality of particles.

2. The optical particle detection system of claim 1, wherein the image of the plurality of particles is formed by the laser light, and the filter is configured to transmit a part of the laser light amplified by the microscope group and formed an image of the at least one target particle.

3. The optical particle detection system of claim 1, wherein the image sensor is configured to sense the laser light having a wavelength less than 400 nm.

4. The optical particle detection system of claim 1, wherein the laser light has a wavelength less than 400 nm.

5. The optical particle detection system of claim 4, wherein the image of the plurality of particles is formed by the laser light, and the filter is configured to transmit a part of the laser light amplified by the microscope group and formed an image of the at least one target particle.

6. The optical particle detection system of claim 4, wherein the image sensor is configured to sense the laser light with a wavelength less than 400 nm.

7. The optical particle detection system of claim 1, wherein an optical path of the laser light between the light source and the lens group forms a non-zero angle with an optical path of the laser light between the lens group and the image sensor.

8. The optical particle detection system of claim 7, wherein the image of the plurality of particles is formed by the laser light, and the filter is configured to transmit a part of the laser light amplified by the microscope group and formed an image of the at least one target particle.

9. The optical particle detection system of claim 7, wherein the image sensor is configured to sense the laser light have a wavelength less than 400 nm.

10. The optical particle detection system of claim 1, wherein the absorber is configured to absorb the plurality of particles with diameters less than or equal to 2.5 μm in the atmosphere.

11. The optical particle detection system of claim 10, wherein the image of the plurality of particles is formed by the laser light, and the filter is configured to transmit a part of the laser light amplified by the microscope group and formed an image of the at least one target particle.

12. The optical particle detection system of claim 10, wherein the image sensor is configured to sense the laser light with a wavelength less than 400 nm.

13. The optical particle detection system of claim 1, wherein the filter is a single pinhole filter and is configured to filter stray light around the image of the plurality of particles.

14. An optical particle detecting method comprising:
obtaining a color picture comprising a color image of a plurality of particles through an image sensor;
binarizing the color picture to obtain a black-and-white picture comprising a black-and-white image of the plurality of particles;
determining whether each of the plurality of particles is a target particle according to a pixel number of the black-and-white image of each of the plurality of particles;
calculating a number of the target particle in the black-and-white picture;
establishing a color model of the target particle according to the color picture and the black-and-white picture; and
comparing the color model of the target particle with a preset color model database of particles to determine a component of the target particle.

15. The optical particle detecting method of claim 14, wherein the determining whether each of the plurality of particles is a target particle comprises marking a position of each of the target particle in the black-and-white picture; and
the establishing a color model of the target particle comprises:
acquiring a color image of the target particle in the color picture according to the position of the target particle in the black-and-white picture; and
establishing the color model of the target particle based on the color image of the target particle in the color picture.

16. The optical particle detecting method of claim 14 further comprising:
defining a particle in the plurality of particles with a diameter less than or equal to A1 as the target particle;
wherein a pixel size of the image sensor is A2, and the determining whether each of the plurality of particles is a target particle comprises:
determining whether the black-and-white image of each of the plurality of particles is less than or equal to A1/A2, wherein each of the plurality of particles is determined to be the target particle if the black-and-white image of each of the plurality of particles is less than or equal to A1/A2.

17. The optical particle detecting method of claim 16, wherein the determining whether each of the plurality of particles is a target particle comprises marking a position of each of the target particle in the black-and-white picture; and
establishing a color model of the target particle comprises:
acquiring a color image of the target particle in the color picture according to the position of the target particle in the black-and-white picture; and
establishing the color model of the target particle based on the color image of the target particle in the color picture.
